(19) United States
(12) Patent Application Publication
(10) Pub. No.: US 2009/0289152 A1
(43) Pub. Date: Nov. 26, 2009

(54) Device and Method for Suspending Telecommunication and Power Cables

(75) Inventors: Robert Crain, O'Fallon, IL (US); Dallas Kellerman, Mascoutah, IL (US)

Correspondence Address: BRYAN CAVE LLP, 211 NORTH BROADWAY, SUITE 3600, ST. LOUIS, MO, 63102-2750, US

(73) Assignee: CABLOFIL, INC., Mascoutah, IL (US)

(21) Appl. No.: 12/124,015

(22) Filed: May 20, 2008

(51) Int. Cl. F16L 3/02; E04B 1/00

(52) U.S. Cl. 248/73; 52/741.1

(57) ABSTRACT

The present invention relates to devices and methods for suspending telecommunication cables, power cables, and other items within a building. According to certain non-limiting embodiments of the present invention, devices for supporting an article are provided. The article may be, for example, one or more telecommunication and/or power cables. According to certain embodiments, the devices comprise a support arm that is adapted to support the article. The support arm is preferably reversibly and adjustably connected to a vertical support. As described herein, the vertical support rests substantially adjacent to a first side of a wall. The apparatus further comprises a horizontal support, which makes contact with at least a portion of the top side of the wall. This horizontal support is, preferably, connected to or integrally formed with the vertical support. In certain embodiments, the devices further comprise a second vertical support, which rests substantially adjacent to a second side of the wall, i.e., the other side of the wall. The second vertical support may be connected to or integrally formed with the horizontal support.

### FIELD OF THE INVENTION

The field of the invention relates to devices and methods for suspending telecommunication cables, power cables, and other items.

### BACKGROUND OF THE INVENTION

Telecommunication and power cables are present and used in most, if not all, commercial buildings today. Of course, such cables are a necessity to bring power to a building, and enable communication with other parties outside the building. Indeed, they are a basic necessity for any commercial building.

It is generally preferred to store telecommunication and power cables, or a substantial portion thereof, outside the view of the casual observer. For example, it is commonplace to store and suspend telecommunication and power cables within the ceiling of a building, such that the cables are not visible. This serves at least two purposes. First, it reduces the possibility of a particular cable, accidentally or purposely, being damaged or severed. Second, it creates a more aesthetically pleasing environment, when such cables are not visible. Importantly, however, these cables must still be readily accessible to maintenance personnel. In other words, the cables should not be contained in a device which prevents easy access to the same by maintenance personnel.

In many cases, telecommunication and power cables have been suspended within a ceiling (or other areas) of a building by placing the cables on a tray (or other device) that is positioned within the ceiling and attached to one or more walls. More particularly, a series of brackets or other devices are routinely attached to one or more walls using, for example, screws, nails, and other mechanical attachment means. The brackets may then hold the cables themselves, or otherwise support a tray or other surface that is capable of suspending and holding the cables.

While the foregoing approach may be effective to suspend a plurality of cables within a ceiling, it suffers from several drawbacks. Specifically, the need to attach the series of brackets or other devices to a wall is labor intensive. Furthermore, since the brackets or other devices are most often attached vis-à-vis a screw, nail, or other attachment means, this approach can be destructive to the walls of a building. Accordingly, a need exists for improved devices and methods for suspending telecommunication cables, power cables, and other items within a building.

### SUMMARY OF THE INVENTION

According to a first aspect of the present invention, devices for supporting an article are provided. The article may be, for example, one or more telecommunication and/or power cables. According to certain embodiments, the devices comprise a support arm that is adapted to support the article. The support arm is preferably reversibly and adjustably connected to a vertical support. As described herein, the vertical support rests substantially adjacent to a first side of a wall. The apparatus further comprises a horizontal support, which makes contact with at least a portion of the top side of the wall. This horizontal support is, preferably, connected to or integrally formed with the vertical support. In certain embodiments, the apparatus further comprises a second vertical support, which rests substantially adjacent to a second side of the wall, i.e., the other side of the wall. The second vertical support may be connected to or integrally formed with the horizontal support.

According to another aspect of the present invention, methods for suspending and holding an article near a top side of a wall are provided. In certain embodiments of the invention, the methods generally comprise attaching a support arm to a vertical support. The support arm may be adapted to hold the article, such as one or more telecommunication cables, power cables, or a combination thereof. The invention provides that the vertical support will, preferably, rest substantially adjacent to a first side of the wall. Next, a horizontal support may be placed on the top side of the wall. This horizontal support is preferably connected to or integrally formed with the vertical support. A second vertical support may also, optionally, be placed substantially adjacent to a second side of the wall. The second vertical support may be connected to or integrally formed with the horizontal support. A second support arm may, optionally, be connected to or integrally formed with the second vertical support. Finally, the article may be placed, directly or indirectly, on the first and/or second support arm.

According to additional aspects of the present invention, kits are provided that may be used to construct the devices and/or carry out the methods described herein.

### BRIEF DESCRIPTION OF THE FIGURES

FIG. 1 is a perspective view of a non-limiting example of a device of the present invention, which is reversibly affixed to the wall shown therein.

FIG. 2 (A) a perspective view of a non-limiting example of a horizontal support portion (and a portion of a first and second vertical support) of a device of the present invention; and (B) is a perspective view of another non-limiting example of a device of the present invention, which comprises two support arms.

FIG. 3 is a perspective view of another non-limiting example of a device of the present invention, which comprises a single support arm.

FIG. 4 is a perspective view of yet another non-limiting example of a device of the present invention, which comprises a single support arm.

### DETAILED DESCRIPTION OF THE INVENTION

According to a first aspect of the present invention, devices for supporting an article are provided. The article may be, for example, one or more telecommunication and/or power cables. The devices are preferably used to hold and suspend the article within the ceiling of a building, or otherwise near the top side of a wall (which may or may not be located above a ceiling line). The invention provides that a plurality of the devices may be attached to the top side of a wall, such that the devices will collectively serve to support and suspend the cables near the top side of the wall. The invention further provides that the plurality of devices are, preferably, attached to the top side of a wall using a non-destructible means. More particularly, the plurality of devices are, preferably, attached to the top side of a wall using methods that do not require the use of screws, nails, adhesives, or other items that are inserted into the wall itself. In certain preferred embodiments, as described herein, the plurality of devices are attached to the top side of a wall, in a stable manner, through a gravity force, a clamping force imparted by such devices, or a combination thereof.

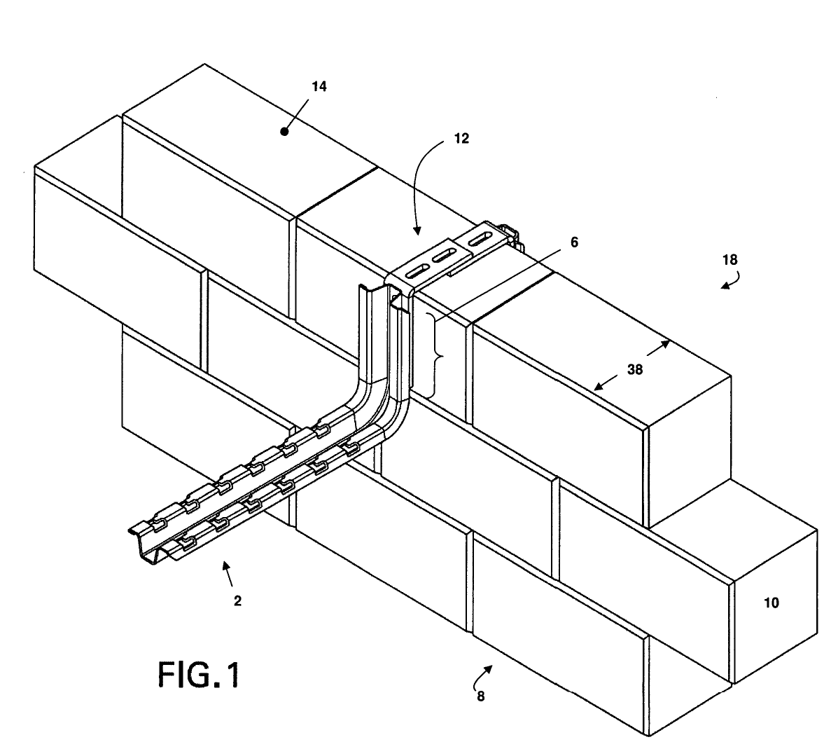

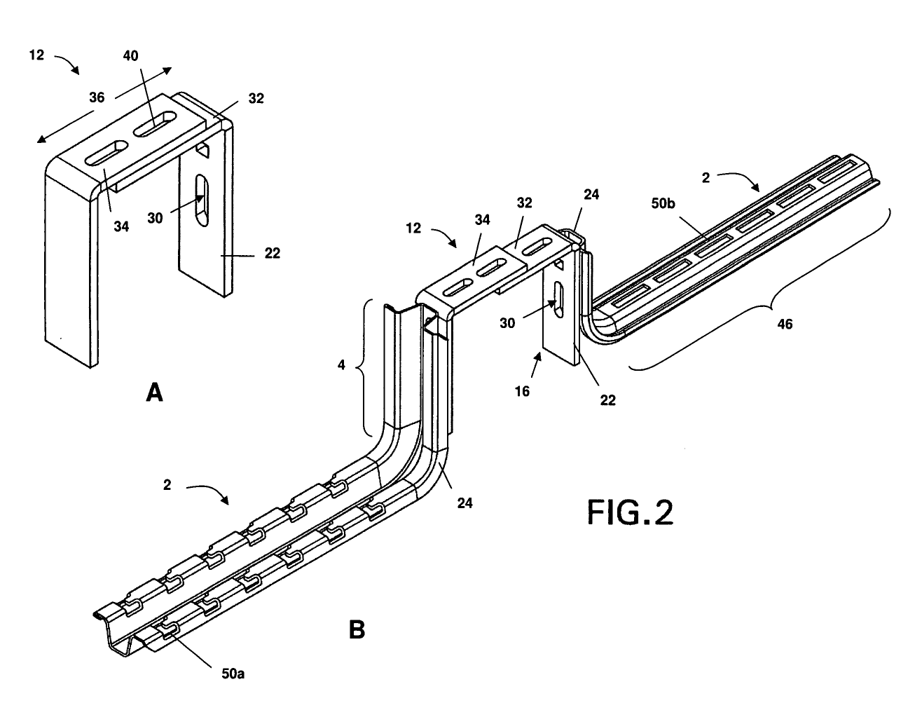

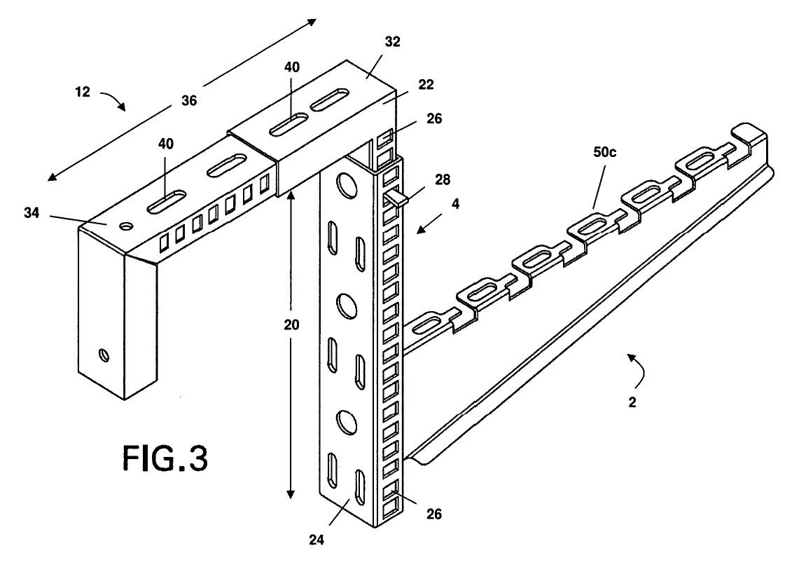

According to certain embodiments, and referring to FIG. 1, the devices comprise a support arm 2 that is adapted to support the article. The support arm 2 is preferably reversibly and adjustably connected to a vertical support 4 (FIGS. 2 and 3). As described herein, the vertical support 4 rests substantially adjacent 6 to a first side 8 of a wall 10 (FIG. 1). The device further comprises a horizontal support 12, which makes contact with at least a portion of the top side 14 of the wall 10. The horizontal support 12 is, preferably, connected to or integrally formed with the vertical support 4. In certain embodiments, the device further comprises a second vertical support 16 (FIG. 2(B)), which is adapted to rest substantially adjacent to a second side 18 of the wall 10 (FIG. 1). The second vertical support 16 may be connected to or integrally formed with the horizontal support 12.

As used herein, the phrase “rests substantially adjacent to,” and similar phrases, generally means that a surface, or portion thereof, of a vertical support (e.g., vertical support 4 or the second vertical support 16) makes contact with a side of the wall 10. In certain embodiments, a significant portion of a vertical support 4,16 will make contact with a side 8,18 of the wall 10, such that it rests substantially adjacent to the wall 10.

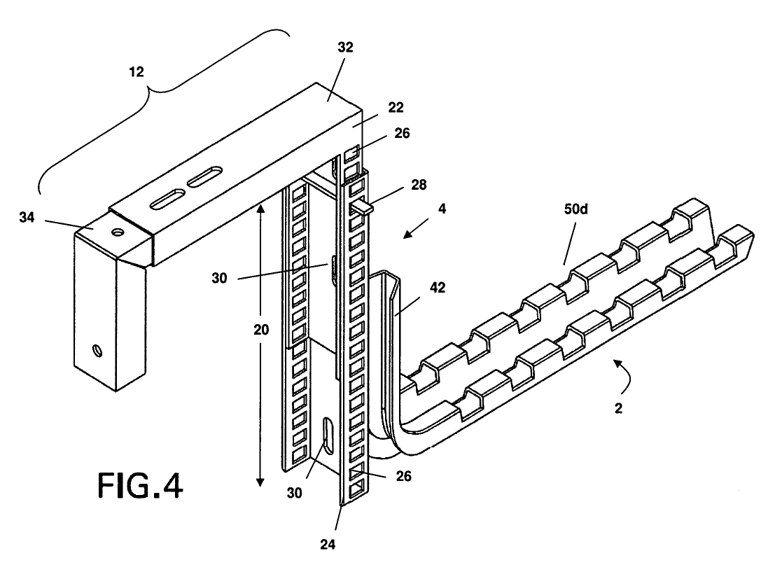

The invention provides that the various components of the devices described herein are adjustable, in order to achieve a device of the desired dimensions and/or to accommodate the size and dimension of a particular wall. More specifically, for example, and referring to FIGS. 3 and 4, the vertical supports 4 and 16 may comprise a first 22 and second 24 slidably engageable part. The first slidably engageable part 22 may be reversibly connected to any of a plurality of positions along a primary axis 20 of the second slidably engageable part 24, such that the total length of the combined first 22 and second 24 slidably engageable part, which together forms a vertical support 4,16, may be varied. As shown in FIGS. 3 and 4, the first 22 and second 24 slidably engageable parts may comprise corresponding apertures 26 along at least a portion of the primary axis 20 thereof. According to such embodiments, a pin 28 (or other member) may be disposed within and through corresponding apertures 26 located in the first 22 and second 24 slidably engageable part, such that the first 22 and second 24 slidably engageable part are substantially locked into position and connected to each other. The invention provides that the first 22 and second 24 slidably engageable part may be slid along the primary axis 20 thereof to lengthen, or shorten, the combined length of such parts, which serves to adjust the total length of the vertical support 4,16. Accordingly, the first 22 and second 24 slidably engageable part may be held stationary at the desired location along the primary axis 20 by disposing one or more pins 28 through corresponding apertures 26 located in the first 22 and second 24 slidably engageable part (as shown, for example, in FIGS. 3 and 4). The invention provides, however, that the means of locking the first 22 and second 24 slidably engageable parts together are not limited to the use of a pin 28, but rather other mechanical means could also be used.

In certain additional embodiments, referring to FIG. 2, the second slidably engageable part 24 may be connected to and/or integrally formed with the support arm 2, such that the second slidably engageable part 24 preferably comprises a portion that will rest substantially adjacent to the vertical support 4,16. According to such embodiments, the second slidably engageable part 24 may be reversibly connected to the vertical support 4,16 along any of various positions along its primary axis 20. The second slidably engageable part 24 may be reversibly connected to the vertical support 4,16 or, more particularly, the first 22 slidably engageable part of the vertical support 4,16 by, for example, disposing a screw/bolt combination (not shown), or other fastener, through corresponding apertures 30 located in both parts 22,24.

The invention provides that the shape and configuration of the first 22 and second 24 slidably engageable parts may vary. In addition, the invention may employ more than two slidably engageable parts. For example, referring to FIG. 4, the invention provides that the vertical support 4,16 may be comprised of its own first 22 and second 24 slidably engageable parts, while a third slidably engageable part 42 may be connected to or integrally formed with the support arm 2, such that the support 2 may also be reversibly attached to different locations along the primary axis 20 of the vertical support 4,16 (e.g., using a screw/bolt combination and corresponding apertures 30 located in the vertical support 4,16 and third slidably engageable part 42). In other embodiments, referring to FIG. 2(B), for example, when a support arm 2 is connected to or integrally formed with its own slidably engageable part, the invention provides that such slidably engageable part may serve as the second slidably engageable part 24, which may be reversibly connected to the first slidably engageable part 22.

While the shape and configuration of the first 22, second 24, and/or third 42 slidably engageable parts may vary, it is preferred that such parts are generally capable of being reversibly connected to each other, as described herein, at different locations along the primary axis 20 of each part, such that the total length of the vertical support 4,16 may be adjusted as desired.

According to further embodiments, the invention provides that the horizontal support 12 comprises a first 32 and second 34 slidably engageable part, which together comprise the horizontal support 12. The first 32 and second 34 slidably engageable part may be reversibly connected to any of a plurality of positions along a primary axis 36 thereof (FIGS. 2 and 3). This feature allows the total combined length of the first 32 and second 34 slidably engageable part, and thus horizontal support 12, to be varied, which may be important to accommodate the width 38 of the wall 10 (FIG. 1). In addition, the total combined length of the first 32 and second 34 slidably engageable part, and thus horizontal support 12, may be adjusted to impart a clamping force on, for example, a top side of a wall. This clamping force will serve to further secure the device to the wall. The first 32 and second 34 slidably engageable part may be secured to each other using any suitable means. For example, a screw/bolt combination (not shown) or other fastener may be disposed through corresponding apertures 40 located along the primary axis 36 of the first 32 and second 34 slidably engageable part (FIG. 3).

The invention further provides that the support arm 2 may be adjustably and reversibly connected to the vertical support 4,16 at any of various locations along the primary axis 20 thereof. For example, a first end of the support arm 2 may be adjustably and reversibly connected to the vertical support 4,16, such that a majority of the support arm 46 (FIG. 2) extends outward and away from the vertical support 4,16. This way, the support arm 2 is capable of supporting an article, such as telecommunication and/or power cables (or, as described below, supporting a tray which holds such cables). The first end of the support arm 2 may be adjustably and reversibly connected to the vertical support 4,16 using any suitable mechanical means. For example, referring to FIG. 3, one or more protruding members (not shown) located at the first end of the support arm 2 may be reversibly disposed within one or more corresponding apertures (not shown) located along the primary axis 20 of the vertical support 4,16.

Alternatively, for example, and referring to FIG. 4, the support arm 2 may comprise a portion 42 (e.g., the third slidably engageable part 42) that is capable of being reversibly attached to any of various positions along the primary axis 20 of a vertical support 4,16. The portion 42 may be configured to comprise a series of apertures (not shown), through which a faster may be disposed to reversibly connect the support arm 2 to the vertical support 4,16 at the desired location along the primary axis 20 thereof. According to such embodiments, the vertical support 4,16 will preferably comprise a series of apertures 30 located along the primary axis 20 thereof. For example, the series of apertures 30 may be located along the surface of the vertical support 4,16 that will face and correspond with the series of apertures of portion 42, such that a faster, e.g., screw/bolt combination, may be disposed through the apertures of portion 42 and the vertical support 4,16, to reversibly connect the support arm 2 to the vertical support 4,16 at the desired location along the primary axis 20 thereof.

The invention provides that the support arm 2 may further comprise a tray, which is adapted to support the article. The tray may be permanently or reversibly attached to the support arms 2 of a series of devices using any suitable means. For example, a tray may be attached to a plurality of support arms 2 using a screw/bolt combination (or other mechanical fasteners), whereby a screw may be disposed through corresponding apertures located in the tray and support arm 2 and bolted together.

In other embodiments, the support arm 2 may include a plurality of engaging elements, which are capable of engaging and receiving a corresponding element located on a bottom side of a tray, such that the tray may be securely attached to the support arm 2 (and, in certain embodiments, without the use of a screw/bolt combination or other fasteners). The shape, size, and configuration of the engaging elements may vary, so long as a correspondingly configured engaging element is located on a bottom side of a tray. Non-limiting examples of such engaging elements 50a-50d are shown in FIGS. 2-4.

The devices described herein may be constructed of any suitable material. For example, the devices may be constructed of stainless steel, aluminum, other metals or alloys, plastics or other polymers, or combinations of the foregoing. In addition, although certain embodiments of the present invention provide that the devices described herein may be secured to a wall without screws, nails, adhesives, or other fastening means that may damage a wall, the invention provides that such fastening means may, optionally, be used to further secure the devices to a wall.

According to yet further embodiments of the present invention, methods for suspending and holding an article near a top side of a wall are provided. In certain embodiments of the invention, the methods generally comprise attaching a series of the devices described herein to a top side of a wall, which comprise one or more support arms, and placing the article on the support arms (or on a tray that is supported by the plurality of support arms). The article may be one or more telecommunication cables, power cables, or a combination thereof. As described above, the invention provides that the devices will comprise a horizontal support, one or more vertical supports, and one or more support arms, with at least one vertical support, preferably, positioned such that it rests substantially adjacent to a first side of a wall. The horizontal support may be placed on the top side of the wall. This horizontal support is preferably connected to or integrally formed with the vertical support. A second vertical support may, optionally, also be placed substantially adjacent to a second side of the wall. The second vertical support may be connected to or integrally formed with the horizontal support.

The total length of the horizontal support 12 will preferably be adjusted to accommodate the width of the top side 38 of the wall 10. As described above, in certain embodiments, the total width of the horizontal support 12 may be adjusted by sliding a first 32 and second 34 slidably engageable part along the primary axis 36 thereof until the desired total length of the horizontal support 12 is achieved, at which point the first 32 and second 34 slidably engageable part may be reversibly connected to each other as described herein. In certain embodiments, the total length of the horizontal support 12 may be adjusted after the horizontal support 12 is placed on the top side 38 of the wall 10, such that the length of the horizontal support 12 may be adjusted to impart a clamping force on the wall (to further secure the device thereto). Finally, a tray may optionally be attached to the support arms of the plurality of devices. The article may then be placed on the plurality of support arms (or tray).

According to additional aspects of the present invention, kits are provided that may be used to construct the devices and/or carry out the methods described herein. For example, a kit encompassed by the present invention may comprise a plurality of the devices described herein (and/or components thereof), such that a series of the devices may be applied to a wall, and used to suspend cables.

Although certain example methods, apparatus, and/or articles of manufacture have been described herein, the scope of coverage of this disclosure is not limited thereto. On the contrary, this disclosure covers all methods, apparatus, and/or articles of manufacture fairly falling within the scope of the appended claims either literally or under the doctrine of equivalents.

What is claimed is:

1. A device for supporting an article, which comprises:
(a) a support arm, which is adapted to support an article;
(b) a vertical support, which rests substantially adjacent to a first side of a wall and is connected to the support arm;
(c) a horizontal support, which makes contact with at least a portion of a top side of the wall and is connected to or integrally formed with the vertical support; and
(d) a second vertical support, which rests substantially adjacent to a second side of the wall and is connected to or integrally formed with the horizontal support.

2. The device of claim 1, which further comprises a second support arm, which is adapted to support an article and is connected to or integrally formed with the second vertical support.

3. The device of claim 1, wherein the support arm is adjustably connected to any of a plurality of positions along a primary axis of the vertical support.

4. The device of claim 1, wherein the vertical support comprises a first and second slidably engageable part, wherein the first slidably engageable part may be reversibly connected to any of a plurality of positions along a primary axis of the second slidably engageable part.

5. The device of claim 1, wherein the horizontal support comprises a first and second slidably engageable part, wherein the first slidably engageable part may be reversibly connected to any of a plurality of positions along a primary axis of the second slidably engageable part.

6. The device of claim 1, wherein the support arm further comprises a tray, wherein the tray is adapted to support the article.

7. The device of claim 6, wherein the article is a plurality of telecommunication cables, power cables, or a combination thereof.

8. The device of claim 6, wherein the tray is connected to the support arm.

9. A device for supporting an article, which comprises:
(a) a support arm that is connected to a tray, which is adapted to support an article;
(b) a vertical support that rests substantially adjacent to a first side of a wall, wherein (i) the support arm is adjustably connected to any of a plurality of positions along a primary axis of the vertical support and (ii) the vertical support comprises a first and second slidably engageable part, wherein the first slidably engageable part may be reversibly connected to any of a plurality of positions along a primary axis of the second slidably engageable part;
(c) a horizontal support, wherein (i) the horizontal support makes contact with at least a portion of a top side of the wall and (ii) the horizontal support comprises a first and second slidably engageable part, wherein the first slidably engageable part may be reversibly connected to any of a plurality of positions along a primary axis of the second slidably engageable part to increase or decrease a total length of the horizontal support; and
(d) a second vertical support, which rests substantially adjacent to a second side of the wall and is connected to or integrally formed with the horizontal support.

10. The device of claim 9, which further comprises a second support arm, which is adapted to support an article and is connected to the second vertical support.

11. A method for suspending and holding an article near a top side of a wall, which comprises:
(a) attaching a support arm to a vertical support, wherein the support arm is adapted to hold the article and the vertical support rests substantially adjacent to a first side of the wall;
(b) placing a horizontal support on the top side of the wall, wherein the horizontal support is connected to or integrally formed with the vertical support;
(c) placing a second vertical support substantially adjacent to a second side of the wall, wherein the second vertical support is connected to or integrally formed with the horizontal support; and
(d) placing the article, directly or indirectly, on the support arm.

12. The method of claim 11, which further comprises attaching a second support arm to the second vertical support, wherein the support arm is adapted to hold the article.

13. The method of claim 11, wherein the support arm is adjustably attached to any of a plurality of positions along a primary axis of the vertical support.

14. The method of claim 11, which further comprises adjusting a total length of the vertical support, wherein the vertical support comprises a first and second slidably engageable part, wherein the first slidably engageable part may be reversibly connected to any of a plurality of positions along a primary axis of the second slidably engageable part to increase or decrease the total length of the vertical support.

15. The method of claim 11, which further comprises adjusting a total length of the horizontal support to match an approximate thickness of the wall, wherein the horizontal support comprises a first and second slidably engageable part, wherein the first slidably engageable part may be reversibly connected to any of a plurality of positions along a primary axis of the second slidably engageable part to increase or decrease the total length of the horizontal support.

16. The method of claim 11, which further comprises attaching a tray to the support arm and placing the article on the tray.

17. The method of claim 11, wherein the article is a plurality of telecommunication cables, power cables, or a combination thereof.

18. A method for suspending and holding an article near a top side of a wall, which comprises:
(a) attaching a support arm to a vertical support, wherein (i) the support arm is attached to the vertical support at any of a plurality of positions along a primary axis of the vertical support and (ii) the support arm is adapted to hold the article;
(b) adjusting a total length of the vertical support, wherein the vertical support comprises a first and second slidably engageable part, wherein the first slidably engageable part may be reversibly connected to any of a plurality of positions along a primary axis of the second slidably engageable part to increase or decrease the total length of the vertical support;
(c) placing the vertical support substantially adjacent to a first side of the wall;
(d) adjusting a total length of a horizontal support to match an approximate thickness of the wall, wherein the horizontal support (i) is connected to or integrally formed with the vertical support and (ii) comprises a first and second slidably engageable part, wherein the first slidably engageable part may be reversibly connected to any of a plurality of positions along a primary axis of the second slidably engageable part to increase or decrease the total length of the horizontal support;
(e) placing the horizontal support on the top side of the wall;
(f) placing a second vertical support substantially adjacent to a second side of the wall, wherein the second vertical support is connected to or integrally formed with the horizontal support; and
(g) placing the article, directly or indirectly, on the support arm.

19. The method of claim 18, which further comprises attaching a second support arm to the second vertical support, wherein the second support arm is adapted to support an article.

20. The method of claim 19, wherein the article is a plurality of telecommunication cables, power cables, or a combination thereof.
